(19) United States
(12) Patent Application Publication
(10) Pub. No.: US 2022/0147901 A1
(43) Pub. Date: May 12, 2022

(54) INFORMATION PROCESSING APPARATUS

(71) Applicant: NTT DOCOMO, INC., Tokyo (JP)

(72) Inventors: Syuusuke WATANABE, Tokyo (JP); Tadashige NAGAE, Tokyo (JP); Mitsuteru FUKUYAMA, Tokyo (JP); Masakazu HAMANO, Tokyo (JP); Takefumi YAMADA, Tokyo (JP); Takashi HARA, Tokyo (JP); Yuichiro SEGAWA, Tokyo (JP); Yasuhiro KITAMURA, Tokyo (JP)

(73) Assignee: NTT DOCOMO, INC., Tokyo (JP)

(21) Appl. No.: 17/438,043

(22) PCT Filed: Mar. 16, 2020
(86) PCT No.: PCT/JP2020/011355

§ 371 Date: Sep. 10, 2021

(30) Foreign Application Priority Data
Mar. 18, 2019 (JP) 2019-049805

(51) Int. Cl. G06Q 10/06; G08G 5/00; G09B 19/16; B64C 39/02

(52) U.S. Cl. CPC G06Q 10/063112; G08G 5/0034; G05D 1/0011; B64C 39/024; G09B 19/165

(57) ABSTRACT

Related information acquiring unit acquires related information related to a facility to be inspected. Related information acquiring unit acquires shape information indicating the shape of a facility as related information. Required skill determining unit determines, when inspection data regarding the facility is acquired by causing drone to make a flight around the facility, a required skill needed to operate drone. Required skill determining unit determines the required skill regarding the facility based on the acquired related information regarding the facility. Required skill determining unit makes determination such that, the higher the level of complexity of a flight route along the shape of the facility that is represented by the acquired related information is, the higher the required skill is. Operation plan generating unit generates an operation plan for causing drone to make a flight while visiting facilities for which the level of the determined skill is the same.

### TECHNICAL FIELD

The present invention relates to a technique for supporting operation of flying bodies.

### BACKGROUND

As a technique for supporting operation of flying bodies, Japanese Patent Application No. 2018-21491A discloses a technique for acquiring rotation information indicating the orientation of a nacelle and the phase of a blade of a wind turbine that is to be inspected and generating data regarding a flight route (inspection route) for an unmanned flying body that acquires data for inspection, based on the rotation information.

### SUMMARY OF INVENTION

There are cases where, when inspection data of a facility (e.g., video of the facility) is acquired by causing a flying body to make a flight around the facility, as in the technique disclosed in Japanese Patent Application No. 2018-21491A, the flying body is operated by a person. There are cases where a difficult operation is required to acquire inspection data depending on the facility, and therefore it is desirable to always assign a highly skilled operator, but the number of highly skilled operators is limited.

Accordingly, an object of the present invention is to support assignment of operators such that inspection data of facilities can be smoothly acquired.

In order to achieve the object described above, the present invention provides an information processing apparatus including an acquiring unit configured to acquire related information related to a facility to be inspected and a determining unit configured to determine, when inspection data regarding the facility is acquired by causing a flying body to make a flight around the facility, a required skill needed to operate the flying body based on the acquired related information.

According to the present invention, assignment of operators can be supported such that inspection data of facilities can be smoothly acquired.

### BRIEF DESCRIPTION OF DRAWINGS

FIG. 1 is a diagram illustrating an example of the overall configuration of a facility inspection system according to an embodiment of the present invention.

FIG. 2 is a diagram illustrating an example of a hardware configuration of a server apparatus according to the present invention.

FIG. 3 is a diagram illustrating an example of a hardware configuration of a drone according to the present invention.

FIG. 4 is a diagram illustrating an example of a hardware configuration of a proportional controller according to the present invention.

FIG. 5 is a diagram illustrating an example of a hardware configuration of a base terminal according to the present invention.

FIG. 6 is a diagram illustrating a functional configuration realized by the apparatuses according to the present invention.

FIG. 7A is a diagram illustrating an example of an extracted pixel according to the present invention.

FIG. 7B is a diagram illustrating an example of an extracted pixel according to the present invention.

FIG. 8A is a diagram illustrating an example of a calculated regression line according to the present invention.

FIG. 8B is a diagram illustrating an example of a calculated regression line according to the present invention.

FIG. 9 is a diagram illustrating an example of a required skill table according to the present invention.

FIG. 10 is a diagram illustrating an example of facility information according to the present invention.

FIG. 11 is a diagram illustrating an example of operator information according to the present invention.

FIG. 12 is a diagram illustrating an example of a displayed operation plan according to the present invention.

FIG. 13 is a diagram illustrating an example of an operating procedure of the apparatuses in determination processing according to the present invention.

FIG. 14 is a diagram illustrating an example of an operating procedure of the apparatuses in generation processing according to the present invention.

FIG. 15A is a diagram illustrating an example of a required skill table of a modification according to the present invention.

FIG. 15B is a diagram illustrating an example of the required skill table of a modification according to the present invention.

FIG. 16A is a diagram illustrating an example of the required skill table of a modification according to the present invention.

FIG. 16B is a diagram illustrating an example of the required skill table of a modification according to the present invention.

FIG. 17 is a diagram illustrating an example of the required skill table of a modification according to the present invention.

FIG. 18 is a diagram illustrating an example of the required skill table of a modification according to the present invention.

FIG. 19 is a diagram illustrating an example of the required skill table of a modification according to the present invention.

FIG. 20 is a diagram illustrating an example of the required skill table of a modification according to the present invention.

FIG. 21 is a diagram illustrating an example of the required skill table of a modification according to the present invention.

FIG. 22 is a diagram illustrating an example of the required skill table of a modification according to the present invention.

FIG. 23 is a diagram illustrating an example of the required skill table of a modification according to the present invention.

### DETAILED DESCRIPTION

### 1. Embodiment

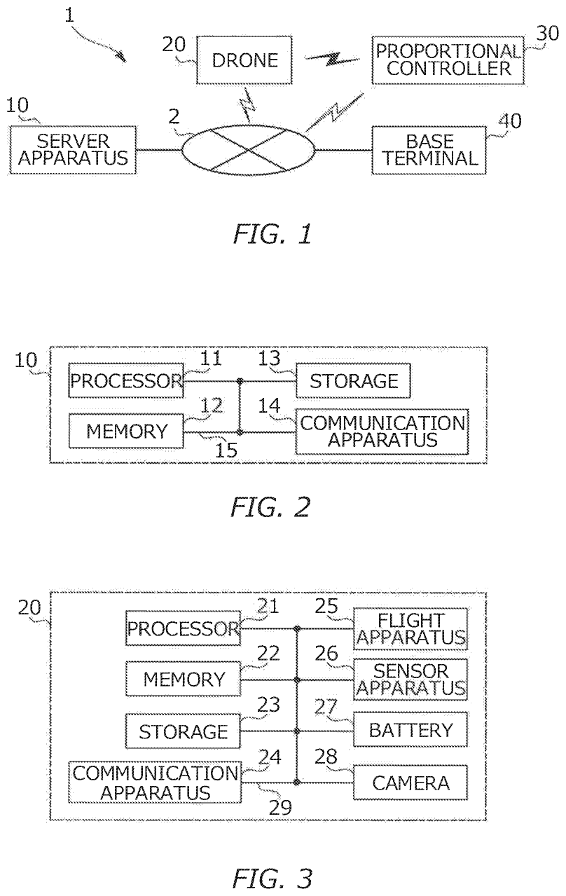

FIG. 1 is a diagram illustrating an example of the overall configuration of facility inspection system 1 according to an embodiment. Facility inspection system 1 is a system for supporting inspection using a flying body equipped with an inspection function of acquiring inspection data from a distanced position in the surrounding area of an inspection target. The inspection target is a facility that is regularly inspected in order to investigate the degree of degradation and damage, and is a bridge, a building, or a tunnel, for example. In the present embodiment, a case where the inspection target is a base station (antenna, in particular) for mobile communication will be described.

The inspection data is data to be used to determine whether or not damage (corrosion, separation, falling, rupture, crack, deformation, discoloration due to degradation, or the like) is present in a facility and whether or not repair is needed. Photographic data obtained by a shooting means, measurement data obtained by an infrared sensor, measurement data obtained by an ultrasonic sensor, or measurement data obtained by a millimeter wave sensor is used as the inspection data, for example. In the present embodiment, photographic data is used as the inspection data.

The determination of whether or not damage is present and whether or not repair is needed, based on the inspection data, is mainly performed by an inspector. The inspector may determine whether or not damage is present or the like by viewing the displayed inspection data, or may also determine whether or not damage is present or the like after causing a computer to perform processing for further analyzing the inspection data (e.g., image processing). Also, a configuration may be adopted in which a computer is also caused to determine whether or not damage is present or the like, if AI (Artificial Intelligence) has developed. That is, the entity that makes determination based on the inspection data is not necessarily limited to a person.

Facility inspection system 1 includes network 2, server apparatus 10, drone 20, proportional controller 30, and base terminal 40. Network 2 is a communications system including a mobile communications network, the Internet, and the like, and relays exchanging of data between apparatuses that access the system. Network 2 is accessed by server apparatus 10 and base terminal 40 through wired communication (may also be wireless communication), and by drone 20 and proportional controller 30 through wireless communication.

In the present embodiment, drone 20 is a rotary wing-type flying body that flies by rotating one or more rotors, and includes a shooting function of taking a photograph, as the inspection function described above. Drone 20 makes a flight in accordance with an operation made by an operator, and acquires inspection data (photographic data of a facility). Drone 20 is deployed in a base such as a business office of an inspection company. Proportional controller 30 (transmitter) is an apparatus that performs proportional control, and is used by the operator to operate drone 20.

The operations of drone 20 include an operation for making a flight of drone 20, and an operation for acquiring inspection data of a facility (e.g., an operation for adjusting a shooting range, a focusing operation, an operation of pressing a photograph button, and the like). Note that acquisition of inspection data may be automatically performed by drone 20. The facilities to be inspected include facilities in which the operation of drone 20 is easy such as a case where drone 20 is simply moved right above the facility and then moved down, and facilities in which the operation of drone 20 is difficult such as a case where the flight direction is changed frequently.

Server apparatus 10 performs processing for determining the skill of an operator needed to acquire inspection data from each facility, processing for generating an operation plan of drone 20 for an operator determined as having the skill to photograph the facility by operating drone 20, and the like. Server apparatus 10 is an example of an “information processing apparatus” of the present invention. Base terminal 40 is installed at a base where drone 20 is deployed, and transmits the generated operation plan to a person concerned, for example.

FIG. 2 shows an example of a hardware configuration of server apparatus 10. Server apparatus 10 may be configured, physically, as computer apparatus that includes processor 11, memory 12, storage 13, communications apparatus 14, bus 15, and the like. Note that in the following description, the term “apparatus” used here can be replaced with “circuit”, “device”, “unit”, or the like.

Also, one or more of each apparatus may be included, and some apparatus may be omitted. Processor 11 controls the computer as a whole by causing an operating system to run, for example. Processor 11 may be constituted by a central processing unit (CPU) including an interface with peripheral apparatuses, a control apparatus, a computational operation apparatus, registers, and the like.

For example, a baseband signal processing unit or the like may be realized by processor 11. Also, processor 11 reads a program (program code), a software module, data, and the like from at least one of storage 13 and communications apparatus 14 into memory 12, and executes various processing according to the read-out program and the like. A program that causes a computer to execute at least some of the operations described in the above embodiment is used as the program.

Although the various processing described above is described as executed by one processor 11, the various processing may be executed simultaneously or sequentially by two or more processors 11. Processor 11 may be implemented using one or more chips. Note that a program may be transmitted from a network over an electrical communication line. Memory 12 is a computer-readable recording medium.

Memory 12 may be constituted by at least one of ROM (Read Only Memory), EPROM (Erasable Programmable ROM), EEPROM (Electrically Erasable Programmable ROM), RAM (Random Access Memory), and so on, for example. Memory 12 may be called as “register”, “cache”, “main memory” (a main storage apparatus), or the like. Memory 12 can store an executable program (program code) for implementing a wireless communication method according to an embodiment of the present disclosure, software modules, and the like.

Storage 13 is a computer-readable recording medium, and for example, may be constituted by at least one of an optical disk such as a CD-ROM (Compact Disc ROM), a hard disk drive, a flexible disk, a magneto-optical disk (for example, a compact disk, a digital versatile disk, or a Blu-ray (registered trademark) disk), a smartcard, a flash memory (for example, a card, a stick, or a key drive), a Floppy (registered trademark) disk, a magnetic strip, and the like.

Storage 13 may be called an auxiliary storage apparatus. The above-mentioned storage medium may be a database, a server, or another appropriate medium including memory 12 and/or storage 13, for example. Communications apparatus 14 is hardware for communicating between computers over a wired and/or wireless network (a transmitting/receiving apparatus). Communication apparatus 14 may also be referred to as a network device, a network controller, a network card, or a communication module, for example.

For example, the transmitting/receiving antenna, amplifier unit, transmitting/receiving unit, transmission path interface, and the like mentioned above may be realized by communication apparatus 14. The transmitting/receiving unit may be implemented by physically or logically separating the transmission unit and the receiving unit. Further, apparatuses such as processor 11 and memory 12 are configured to be connected by bus 15 for communicating information. Bus 15 may be configured using a single bus, or may be configured by using a different bus for each apparatus.

FIG. 3 is a diagram showing an example of a hardware configuration of drone 20. Physically, drone 20 may be configured as a computer apparatus including processor 21, memory 22, storage 23, communication apparatus 24, flight apparatus 25, sensor apparatus 26, battery 27, camera 28, bus 29, and the like. Hardware having the same name as that shown in FIG. 2 such as processor 21 is the same kind of hardware as that shown in FIG. 2, but differs in performance, specifications, and the like.

Communication apparatus 24 has a function of communicating, in addition to communicating with network 2, with proportional controller 30 (for example, a function of wireless communications by radio waves in the 2.4 GHz band). Flight apparatus 25 is an apparatus that includes a motor, a rotor, and the like, and causes the self-drone to fly. Flight apparatus 25 can move the self-drone in any direction in the air, or can make the self-drone stationary (hover).

Sensor apparatus 26 is an apparatus having a sensor group that acquires information necessary for flight control. Sensor apparatus 26 includes, for example, a position sensor that measures the position (latitude and longitude) of the self-drone, a direction sensor that measures the direction drone 20 is facing (the direction in which a forward direction that is defined for the drone is directed), and an altitude sensor that measures the altitude of the self-drone.

Also, sensor apparatus 26 includes a speed sensor that measures the speed of drone 20 and an inertial measurement sensor (IMU (Inertial Measurement Unit)) that measures the angular velocity around three axes and the acceleration in three directions. Battery 27 is an apparatus that accumulates electric power and supplies the electric power to the units of drone 20. Camera 28 includes an image sensor, optical components, and the like, and photographs objects that are present in a direction in which a lens is directed.

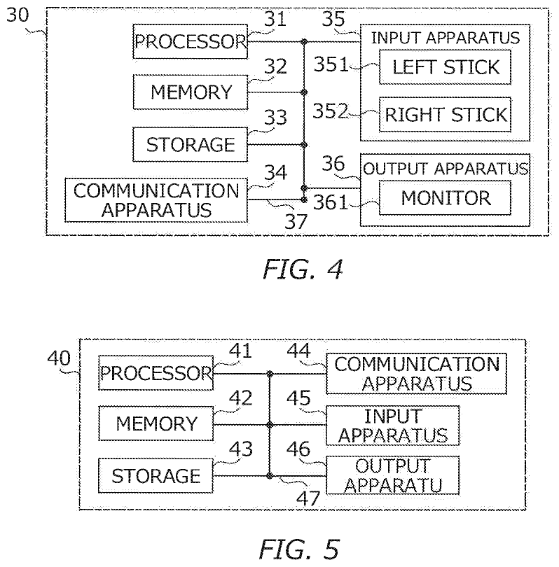

FIG. 4 shows an example of a hardware configuration of proportional controller 30. Proportional controller 30 may be configured as a physical computer apparatus including processor 31, memory 32, storage 33, communication apparatus 34, input apparatus 35, output apparatus 36, bus 37, and the like. Hardware having the same name as that shown in FIG. 2 such as processor 31 is the same kind of hardware as that shown in FIG. 2, but differs in performance, specifications, and the like.

Input apparatus 35 is an input device (e.g., a switch, a button, a sensor, and the like) for receiving input from an external device. In particular, input apparatus 35 includes left stick 351 and right stick 352, and receives the operations performed on the sticks as operations for moving drone 20 in a front and back direction, an up and down direction, a left and right direction, and a rotation direction of drone 20. Output apparatus 36 is an output device (e.g., a monitor 361, a speaker, an LED (Light Emitting Diode) lamp, and the like) for performing output to an external device. Note that input apparatus 35 and output apparatus 36 may also be integrally configured (e.g., monitor 361 is a touchscreen).

FIG. 5 shows an example of a hardware configuration of base terminal 40. Base terminal 40 may be configured as a physical computer apparatus including processor 41, memory 42, storage 43, communication apparatus 44, input apparatus 45, output apparatus 46, bus 47, and the like. Hardware having the same name as that shown in FIG. 2 or 4 such as processor 41 is the same kind of hardware as that shown in FIG. 2 or 4, but differs in performance, specifications, and the like. Note that input apparatus 45 may also be a keyboard, a mouse, a microphone, or the like in addition to the input device described above, for example.

Also, each apparatus described above may also be constituted by including hardware such as a microprocessor, a digital signal processor (DSP), an ASIC (Application Specific Integrated Circuit), a PLD (Programmable Logic Device), or an FPGA (Field Programmable Gate Array). Also, in each apparatus described above, some of or all of the functional blocks may be realized by hardware. For example, processor 11 may be implemented by at least one piece of hardware.

Functions in the apparatuses included in facility inspection system 1 are realized, by causing predetermined software (programs) to be loaded on hardware such as the respective processors and memories, by the processors performing computational operations to control communication by the respective communication apparatuses, to control at least one of reading and writing of data in the memories and storages, and the like.

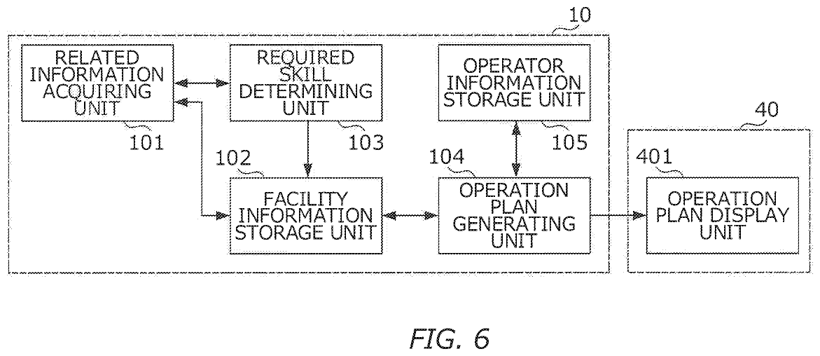

FIG. 6 shows a functional configuration realized by the apparatuses. Server apparatus 10 includes related information acquiring unit 101, facility information storage unit 102, required skill determining unit 103, operation plan generating unit 104, and operator information storage unit 105. Base terminal 40 includes operation plan display unit 401. Related information acquiring unit 101 acquires related information relating to a facility to be inspected. Related information acquiring unit 101 is an example of an “acquiring unit” of the present invention.

The related information includes, in addition to information regarding the facility itself, of course, information regarding the surrounding area of the facility, information regarding a procedure to be performed on the facility (acquisition of inspection data, and the like), and the like. In the present embodiment, related information acquiring unit 101 acquires shape information indicating the shape of the facility as the related information. In the present embodiment, related information acquiring unit 101 acquires the shape information regarding the facility from facility information storage unit 102.

Facility information storage unit 102 has a function of storing facility information that is information regarding a facility on which inspection is to be performed, and in the present embodiment, information regarding a base station is stored as the facility information. Facility information storage unit 102 stores facility information that includes at least the position of an antenna facility installed in a base station, information such as an orientation and a height from the ground at which a photograph is to be taken, a facility ID for identifying the facility, and the aforementioned shape information (information indicating the shape of the antenna facility), for example.

The shape information is image information representing a picture obtained by shooting an external appearance of an antenna facility, and is image information representing a design drawing, for example. The shape information is registered to facility inspection system 1 by a company that has installed the facility, a company that owns the facility, a company entrusted by the company, or the like, and is stored in facility information storage unit 102. Related information acquiring unit 101 acquires the facility ID and related information of each facility, and supplies the acquired facility ID and the like to required skill determining unit 103.

Required skill determining unit 103 determines the skill needed to operating drone 20 when drone 20 is caused to make a flight around a facility, and inspection data of the facility is acquired. Required skill determining unit 103 is an example of a “determining unit” of the present invention. Required skill determining unit 103 determines the skill needed for a facility for which related information has been acquired, based on the related information regarding the facility acquired by related information acquiring unit 101.

The operator skill is represented by an operation time that is the accumulated time that has been spent operating drones, for example. Specifically, if the operation time is up to 50 hours, the skill is represented as “Low”, if the operation time is from 50 hours to 100 hours, the skill is represented as “Medium”, and if the operation time is 100 hours or more, the skill is represented as “High”, for example. Note that, if a time for performing an operation to simply make a drone fly (operation time of flight only), and a time for performing an operation to acquire inspection data while making a drone fly (operation time of also performing inspection) are calculated, the operation time may include both times, or include only the operation time of also performing inspection.

Also, the time of an operation for acquiring inspection data in addition to a flight operation is of use as a reference when the level of required skill is determined, and therefore the operation time may also be obtained by adding the operation time of also performing inspection to which weight is added and the operation time of flight only. Also, the operator's skill may also be represented by the type of license qualified by organizations regarding drones (qualified for each operation skill), instead of the operation time.

In the present embodiment, required skill determining unit 103 makes a determination such that, as the level of complexity of a flight route along the shape of a facility that is represented by the acquired related information increases, the required skill increases. Required skill determining unit 103 extracts an outline of an antenna facility from the shape information (above-mentioned image information) acquired as the related information, for example. It is desirable that the outline to be extracted is an outline of side faces, of the antenna facility, that are photographed by drone 20.

Required skill determining unit 103 extracts the outline in a state in which the Y-axis direction, out of the X-axis direction (left and right direction) and the Y-axis direction (up and down direction) of an image, matches the vertical direction of the antenna facility, for example. Pixels representing the extracted outline are each represented by coordinates (x and y). Required skill determining unit 103 further extracts a pixel whose x coordinate is largest from a pixel group of the same y coordinate, from the extracted outline. The outline represented by the extracted pixels represents the outline of a side face of the facility.

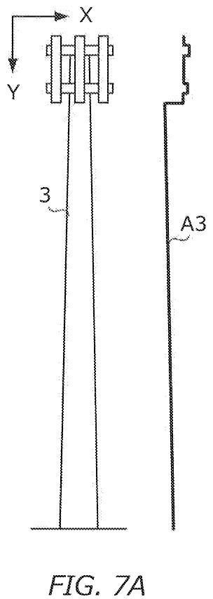

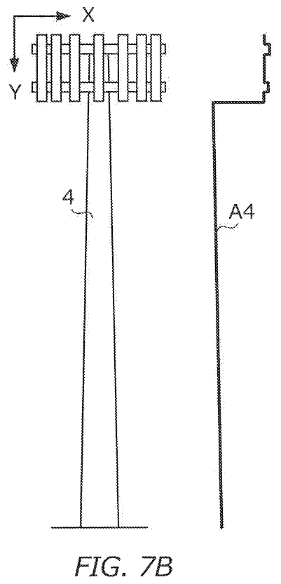

FIGS. 7A and 7B show examples of extracted pixels. In FIG. 7A, antenna facility 3 and side face outline A3 are shown, and in FIG. 7B, antenna facility 4 and side face outline A4 are shown. Antenna facility 4 has a larger number of antennas than antenna facility 3, and the antenna portion extends in the horizontal direction by an amount corresponding to the amount of increase in the number of antennas. Therefore, side face outline A4 changes largely relative to side face outline A3 in the horizontal direction. Required skill determining unit 103 calculates regression lines and variances in outlines A3 and A4. The variance may be calculated using a known method such as a least squares method.

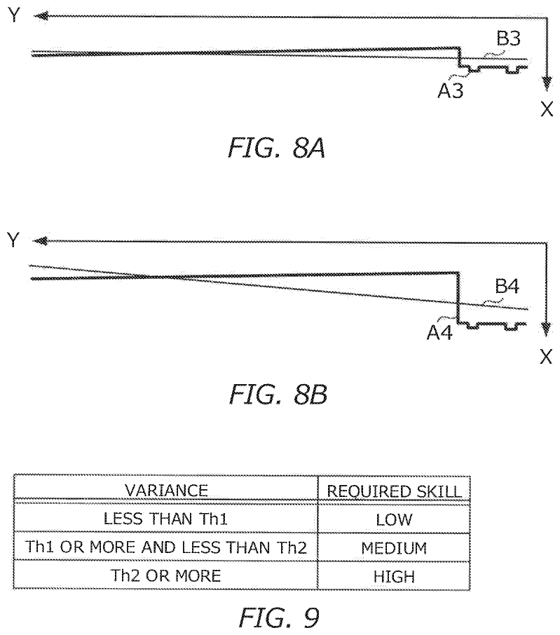

FIGS. 8A and 8B show examples of calculated regression lines. In FIG. 8A, regression line B3 of outline A3 is shown, and in FIG. 8B, regression line B4 of outline A4 is shown. As shown in the diagrams, outline A3 is closer to a straight line than outline A4, and therefore the variance is smaller in outline A3 than outline A4. It is conceivable that the larger the variance calculated in this way, the greater the level of complexity of the flight route along the shape of a facility.

Note that, in the examples in FIGS. 7A and 7B, required skill determining unit 103 calculates the variances using only the outlines obtained by viewing antenna facilities 3 and 4 in one direction, but the method of calculating the variance may also be such that variances are respectively calculated using outlines obtained by viewing in a plurality of directions (desirably outlines of side faces to be photographed by drone 20), and the average of the calculated variances is the variance. Required skill determining unit 103 makes a determination such that the required skill increases as the level of complexity of the flight route increases, and therefore determination is performed using a required skill table in which calculated variances are each associated with required skill.

FIG. 9 shows an example of the required skill table. In the example in FIG. 9, variances, namely “less than Th1”, “Th1 or more and less than Th2”, and “Th2 or more” are respectively associated with “Low”, “Medium”, and “High” skills. Required skill determining unit 103 determines that if the variance of outline A3 is “less than Th1”, the operation skill of drone 20 needed to acquire inspection data of antenna facility 3 is “Low”, for example.

Also, required skill determining unit 103 determines that if the variance of outline A3 is “Th1 or more and less than Th2”, the operation skill of drone 20 needed to acquire inspection data of antenna facility 3 is “Medium”. Required skill determining unit 103 supplies the determined skill (required skill) to facility information storage unit 102. Facility information storage unit 102 stores the supplied required skill as the facility information.

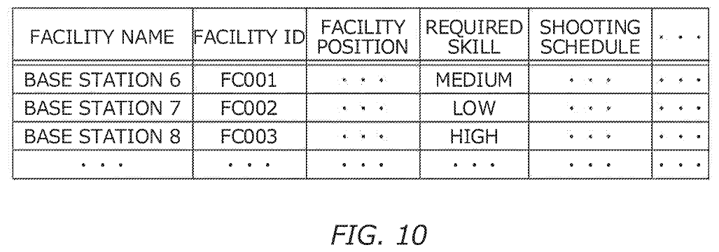

FIG. 10 shows an example of the facility information. In the example in FIG. 10, facility information storage unit 102 stores a facility name, a facility ID, a facility position, required skill, and a shooting schedule (scheduled date to be photographed), and the like, as the facility information. In the example in FIG. 10, the required skill for base station 6 is “Medium”, the required skill for base station 7 is “Low”, and the required skill for base station 8 is “High”.

Operation plan generating unit 104 generates an operation plan for causing drone 20 to make a flight around facilities for which the skill level determined by required skill determining unit 103 is the same. Operation plan generating unit 104 is an example of a “generating unit” of the present invention. Operation plan generating unit 104 creates an operation plan using facility information stored in facility information storage unit 102 and operator information stored in operator information storage unit 105.

Operator information storage unit 105 stores information regarding an operator (operator information) that is registered in facility inspection system 1. Registration and updating of the operator information is performed using base terminal 40, for example.

FIG. 11 shows an example of the operator information. In the example in FIG. 11, operator information storage unit 105 stores information in which an operator name (α, β, γ), an operator ID, an operation time, and a shooting schedule/target facility are associated with each other, as the operator information.

Assume that operators α, β, and γ work at a base where drone 20 is deployed, and can visit base stations by carrying drone 20 in a car. When an operator inputs an operation time to base terminal 40 after operating drone 20, for example, operator information storage unit 105 updates the operation time by adding the input operation time. Operation plan generating unit 104 makes a determination such that, if the operation time is less than 50 hours, the operator skill is “Low”, if the operation time is 50 hours or more and less than 200 hours, the operator skill is “Medium”, and if the operation time is 200 hours or more, the operator skill is “High”, for example.

The date of shooting a facility and the facility to be photographed by an operator operating drone 20 following an operation plan generated by operation plan generating unit 104 are reflected in the shooting schedule/target facility. Operation plan generating unit 104 selects one base station for which shooting has not been determined in the facility information, for example. If base station 6 is selected, operation plan generating unit 104, for example, extracts a base station for which the required skill is “Medium” that is the same as base station 6.

Operation plan generating unit 104 specifies a combination of base stations that can be visited in addition to base station 6, with the base of drone 20 being the starting point, before a predetermined arrival time to the base, based on the positions of the extracted base stations. Operation plan generating unit 104 makes a determination assuming that 30 km can be travelled in an hour, and shooting takes two hours per facility, as a premise for specifying the combination, for example. Note that the premise stated here is merely an example, and may be determined according to the actual state.

Operation plan generating unit 104 specifies the combination of base stations that determined in this way and for which the required skill is “Medium” as the facilities to be photographed by the operator γ whose skill is determined as being “Medium” (that is, the operation time is 50 hours or more and less than 200 hours), for example. Operation plan generating unit 104, upon determining the photographic date, reflects the determined date in the “shooting schedule” of the facility information of a base station specified to be photographed, and also reflects it in the “shooting schedule/target facility” of the operator information of operator γ.

Operation plan generating unit 104 selects another base station for which the shooting schedule has not been determined, determines the shooting schedule, base stations to be photographed on the same day, and a photographer in charge of shooting, and reflects the determined items in the facility information and the operator information, similarly to the manner described above. Operation plan generating unit 104 repeatedly performs the processing described above, and determines the shooting schedule and the operators in charge of shooting in a predetermined period or in predetermined base stations. The predetermined period may be one year, one month, one week, or one day.

Also, the predetermined base stations may all be base stations, or some base stations. Operation plan generating unit 104 generates an operation plan indicating the determined shooting schedule, facilities to be photographed, and operators in charge of shooting, and transmits the generated operation plan to base terminal 40, for example. Operation plan display unit 401 of base terminal 40 displays the operation plan transmitted from server apparatus 10. The operation plan is displayed according to an operation made by a person in charge of operation management at the base, for example.

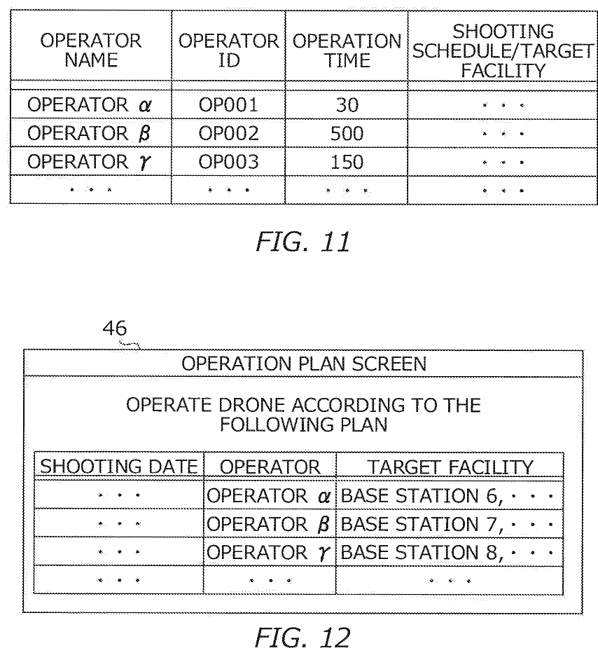

FIG. 12 shows an example of a displayed operation plan. In the example in FIG. 12, operation plan display unit 401 displays a list in which the shooting date, the operator, and the target facilities are associated. Also, in the example in FIG. 12, operator γ whose skill is determined to be “Medium” is associated with target facilities including base station 6 for which the required skill is “Medium”. Also, operator α whose skill is determined as being “Low” is associated with target facilities including base station 7 for which the required skill is “Low”, and operator β whose skill is determined as being “High” is associated with target facilities including base station 8 for which the required skill is “High”.

The apparatuses included in facility inspection system 1 perform determination processing for determining the required skill with respect to each facility, and generation processing for generating an operation plan based on the determined required skills, based on the configuration described above.

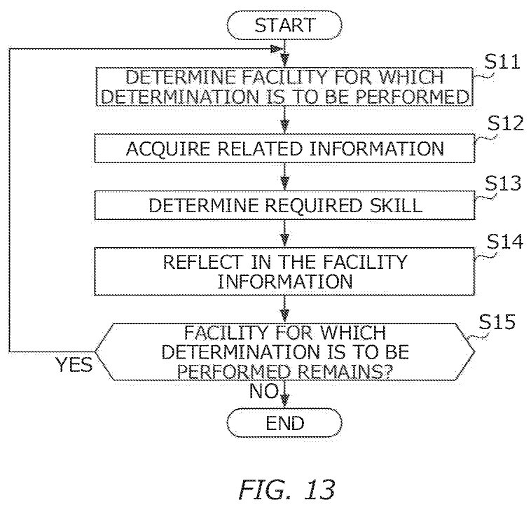

FIG. 13 shows an example of an operating procedure of the apparatuses in the determination processing. The operating procedure shown in FIG. 13 is started regularly or in response to a new facility being installed, for example.

First, server apparatus 10 (related information acquiring unit 101) determines a facility for which determination is to be performed (step S11), and acquires related information (shape information in the present embodiment) regarding the determined facility (step S12). Next, server apparatus 10 (required skill determining unit 103) determines the required skill regarding the determined facility (step S13). Then, server apparatus 10 (facility information storage unit 102) reflects the determined required skill in the facility information (step S14).

Then, server apparatus 10 determines whether or not there is still a facility for which determination has not been made (step S15). If it is determined that a pertinent facility remains (YES), server apparatus 10 returns the processing to step S11, and performs the processing in step S11, and if it is determined that a pertinent facility does not remain (NO), ends the operating procedure in FIG. 13.

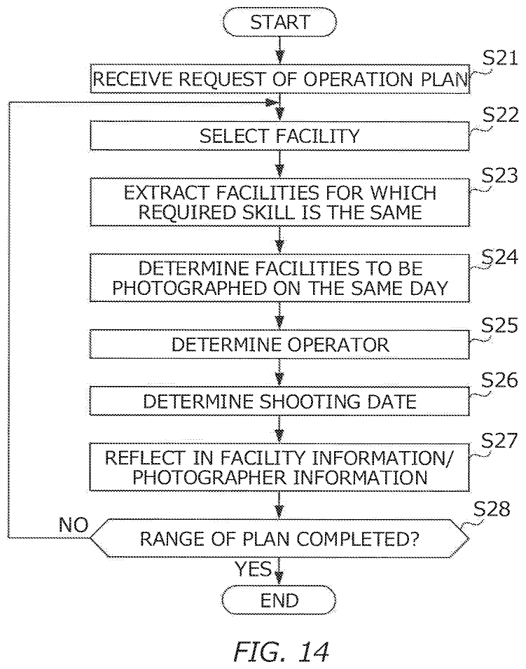

FIG. 14 shows an example of the operating procedure of the apparatuses in the generation processing. The operating procedure in FIG. 14 is started in response to a person in charge of operation management of the base performing an operation to display an operation plan to base terminal 40, for example. First, upon receiving a request for an operation plan (step S21), the server apparatus 10 (operation plan generating unit 104) selects a facility for which a shooting date and the like are to be determined (step S22).

Next, server apparatus 10 (operation plan generating unit 104) extracts facilities for which the required skill is the same as that of the selected facility (step S23), and determines facilities to be photographed on the same day, based on the positions of the facilities (step S24). Then, server apparatus 10 (operation plan generating unit 104) determines an operator having a required skill regarding the selected facilities as the person in charge of shooting the determined facilities that are to be photographed (step S25), and determines a shooting date (step S26).

Next, server apparatus 10 (operation plan generating unit 104) reflects the determined facilities to be photographed, the photographer, and the shooting date in the facility information and the photographer information (step S27). Then, server apparatus 10 (operation plan generating unit 104) determines whether or not the range of the operation plan to be generated is completed (step S28). If it is determined that the range has not been completed (NO), server apparatus 10 returns the processing to step S22, and performs the processing in step S22, and if it is determined that the range has been completed (YES), ends the operating procedure in FIG. 14.

As described above, in the present embodiment, assignment of an operator having the required skill determined based on the related information regarding the facility, that is, assignment of an operator who can smoothly acquire inspection data of facilities can be supported. Also, in the present embodiment, the required skill is determined based on the shape information regarding a facility. The shape information regarding a facility is information that can be obtained from when the facility is installed (before installation, in some cases), and therefore, the determination can be performed in advance, and the processing load incurred when the operation plan is generated can be reduced.

Also, in the present embodiment, an operation plan for visiting, on the same day, facilities for which the level of the required skill is the same is generated. In order to smoothly acquire the inspection data, an operator having the required skill need only be assigned, and therefore, there is no limitation to visiting facilities for which the level of the required skill is the same on the same day. However, as a result of making the level of the required skill the same, as described above, the number of operators who visit facilities on the same day can be easily set to one, compared with the case where the level of the required skill is not made the same, and the human resource planning of operations can be easily performed.

### 2. Modifications

The above-described embodiment is merely an example of implementation of the present invention, and may be modified as follows. In addition, the embodiment and the modifications may be combined as needed. When the embodiment and the modifications are combined, the invention may be implemented by assigning priorities to the modifications (by assigning a priority that decides which modification will be given priority when an event occurs that competes when modifications are implemented).

Also, as a specific combination method, a method may be employed in which modifications in which different parameters are used for obtaining a common index (e.g., required skill) are combined, and the common index is obtained by using the parameters together, for example. Also, a configuration may also be employed such that one index is obtained by integrating indices obtained separately following some sort of rule. Also, when obtaining the common index, different weighting may be performed on parameters to be used.

2-1 Weather Information

The related information related to a facility to be inspected is not limited to shape information described in the embodiment. In this modification, related information acquiring unit 101 acquires information indicating the weather around a facility to be inspected (weather information) as the related information. The weather information is information indicating weather factors that are likely to affect the flight of drone 20 such as wind speed and precipitation amount, for example.

Related information acquiring unit 101 acquires weather forecast information of an area including the position of a facility to be inspected from a system of a provider of a weather forecast service or the like, and acquires the wind speed and precipitation amount included in the weather forecast as weather information. Required skill determining unit 103 makes a determination such that the larger the degree of disturbance on flight by weather indicated by related information (weather information) regarding a facility that is acquired by related information acquiring unit 101, the higher the required skill for the facility.

For example, as the wind speed indicated by the weather information increases, or as the precipitation amount indicated by the weather information increases, the degree of disturbance on flight increases. Making a determination such that the larger the degree of disturbance, the higher the required skill means that a high wind speed or a large precipitation amount corresponds to high required skill. Therefore, required skill determining unit 103 performs determination using a required skill table in which the wind speed or precipitation amount is associated with the required skill.

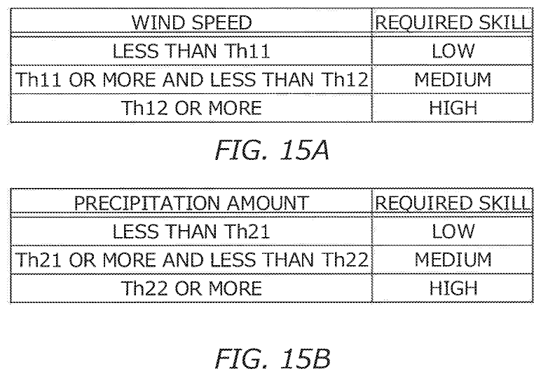

FIGS. 15A and 15B show examples of the required skill table in this modification. In the example in FIG. 15A, wind speeds of “Less than Th11”, “Th11 or more and less than Th12”, and “Th12 or more”, are associated with the “Low”, “Medium”, and “High” required skills. In the example in FIG. 15B, precipitation amounts of “Less than Th21”, “Th21 or more and less than Th22”, and “Th22 or more” are associated with the “Low”, “Medium”, and “High” required skills.

Required skill determining unit 103 determines that, if the wind speed included in weather forecast is “Th11 or more and less than Th12”, the required skill is “Medium”, for example. Also, required skill determining unit 103 determines that, if the precipitation amount included in weather forecast is “Th22 or more”, the required skill is “High”. Note that, when both the wind speed and precipitation amount are used, required skill determining unit 103 may also determine the higher of the required skills associated in the required skill table as the required skill regarding the facility, for example.

Note that related information acquiring unit 101 may also acquire weather information by analyzing a video captured by a monitoring camera installed at a place of interest or in the vicinity of the place of interest, in addition to the method described above. Also, the weather information may include items such as, not limited to the wind speed and precipitation amount, whether or not fog is present (situation in which the degree of difficulty in operation increases due to visibility degradation), snowfall amount (situation in which the degree of difficulty in operation increases due to visibility degradation and snow attachment), and extreme low temperatures and extreme high temperatures (situation in which the degree of difficulty in operation increases due to degradation in flying body performance), for example.

As described above, in this modification, the required skill is determined considering the weather conditions that affect the difficulty in operation of drone 20. Therefore, according to this modification, a situation in which a drone falls due to insufficient skill in bad weather is unlikely to occur, compared with a case where the weather information is not considered.

2-2 Specification of Flying Body

Depending on the specifications of drone 20, there are cases where insufficient skill is made up for, or conversely where higher skill is required. Also, if the specifications of drones 20 differ, there are cases where the likelihood of a failure occurring or the repair cost differs if drone 20 does happen to fall. Therefore, in this modification, the required skill is determined giving consideration to the specifications of drone 20.

In this modification, related information acquiring unit 101 further acquires specification information regarding drone 20. The specification information is information such as the size, number of channels, motor output, attitude keeping function, and hovering function of a flying body, for example. The attitude keeping function is a function of maintaining a state in which the front and back direction and left and right direction of drone 20 are kept along the horizontal direction (that is, the flying body does not lean). Also, the hovering function is a function of maintaining the state of hovering at a specific position in the air.

Related information acquiring unit 101 acquires the specification information from an external apparatus (e.g., base terminal 40) that stores the specification information of drone 20, for example. Required skill determining unit 103, when determining the required skill, reads out the specification information from related information acquiring unit 101, in addition to the related information. Required skill determining unit 103 determines the required skill based on the pieces of read-out information, namely the related information regarding a facility and the specification information acquired by related information acquiring unit 101.

Required skill determining unit 103 performs determination in this modification using a required skill table prepared for the specifications of each drone 20.

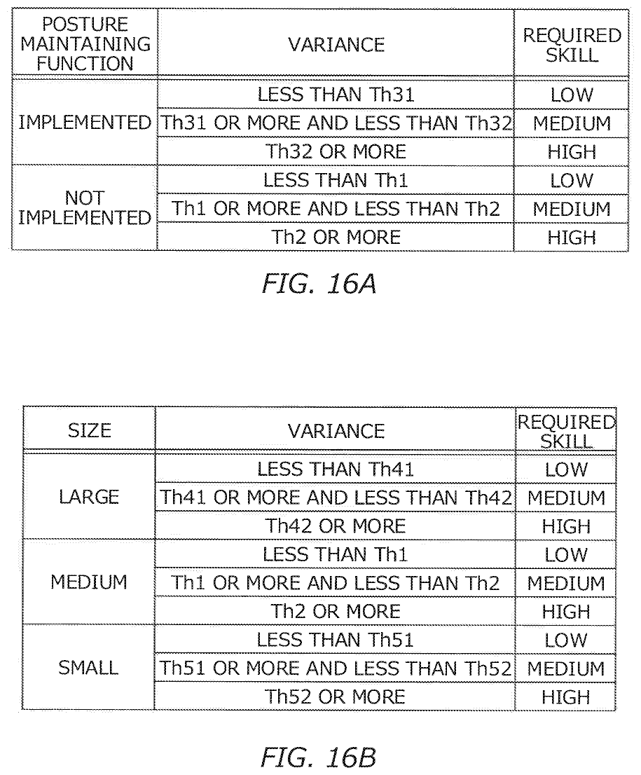

FIGS. 16A and 16B show examples of the required skill table in this modification. In the example in FIG. 16A, the cases of the posture maintaining function being “Implemented” and “Not Implemented” are each associated with variances and required skills.

For example, in the case of the posture maintaining function being “Not Implemented”, the variances of “Less than Th1”, “Th1 or more and less than Th2”, and “Th2 or more” are respectively associated with the “Low”, “Medium”, and “High” required skills, which is the same as that of the example in FIG. 9. Also, in the case of the posture maintaining function being “Implemented”, the variances of “Less than Th31”, “Th31 or more and less than Th32”, and “Th32 or more” are respectively associated with the “Low”, “Medium”, and “High” required skills. In the example in FIG. 16A, the magnitude relationship of the thresholds is assumed to be Th31>Th1, and Th32>Th2.

For example, in the case of a facility for which the variance is Th1 or more and less than Th31, if the posture maintaining function is “Not Implemented”, the required skill is “Medium”, and if the posture maintaining function is “Implemented”, the required skill is “Low”. As described above, upon acquiring the specification information indicating whether or not the posture maintaining function is implemented, required skill determining unit 103 makes a determination such that the required skill is reduced if the acquired specification information indicates that the posture maintaining function is implemented, compared to the case where the acquired specification information indicates that the posture maintaining function is not implemented.

In other words, required skill determining unit 103 makes a determination such that the required skill in the case where the posture maintaining function is implemented is lower than the required skill in the case where the posture maintaining function is not implemented. Also, required skill determining unit 103 makes a determination such that, in the case where the specification information indicates whether or not the hovering function is implemented as well, the required skill in the case where the hovering function is implemented is lower than the required skill in the case where the hovering function is not implemented.

In this modification, as a result of using a determination method in which the specifications of drone 20 are considered, as described above, the required skill is reduced if a drone having a function of making up for insufficient skill of an operator (posture maintaining function, hovering function, and the like) is used, compared to the case where determination is performed without considering the specifications, and therefore, the number of operators that can be assigned increases, and the human resource planning of operations can be easily performed.

Also, in the example in FIG. 16B, the drone sizes “Large”, “Medium”, and “Small” are each associated with variances and required skills. For example, in the case where the size is “Medium”, variances and required skill that are the same as those in the example of “Not Implemented” in FIG. 16A are assigned. Also, in the case where the size is “Large”, variances of “Less than Th41”, “Th41 or more and less than Th42”, and “Th42 or more” are respectively associated with required skills of “Low”, “Medium”, and “High”.

Also, in the case where the size is “Small”, variances of “Less than Th51”, “Th51 or more and less than Th52”, and “Th52 or more” are respectively associated with “Low”, “Medium”, and “High” required skills. In the example in FIG. 16B, the magnitude relationship of the thresholds is assumed to be Th51>Th1>Th41 and Th52>Th2>Th42. Therefore, in the case of a facility for which the variance is Th1 or more and less than Th51, if the drone size is “Medium”, the required skill is “Medium”, and if the drone size is “Small”, the required skill is “Low”, for example.

Also, in the case of a facility regarding which the variance is Th42 or more and less than Th2, if the drone size is “Medium”, the required skill is “Medium”, and if the drone size is “Large”, the required skill is “High”. As described above, upon acquiring the specification information indicating the drone size, required skill determining unit 103 makes a determination such that the larger the drone size indicated by the acquired specification information, the higher the required skill.

As the drone size of a drone increases, the weight increases, and therefore the impact at the time of a fall increases, and the drone is likely to be damaged. Also, the larger the size, the higher the price of the replacement part, in general. Therefore, as a result of performing determination considering the drone size, as described above, the risk incurred when a drone falls (risk regarding damage and risk regarding cost) can be reduced, relative to the case where the drone size is not considered.

When the specification information indicates the number of channels of a drone, required skill determining unit 103 makes a determination such that the larger the number of channels of a drone that is indicated by the acquired specification information, the higher the required skill. Also, if the specification information indicates the motor output of a drone, required skill determining unit 103 makes a determination such that the larger the motor output of a drone that is indicated by the acquired specification information, the higher the required skill.

As the number of channels of a drone increases, the drone can more freely fly, and as the motor output of a drone increases, the drone can be caused to fly at a higher speed. On the other hand, free flight and flight at a high speed increase the degree of difficulty in operating a drone. Therefore, as a result of performing determination considering the number of channels of a drone, as described above, the skill needed to operate the drone can be accurately determined, compared with the case where the number of channels of a drone is not considered.

2-3 Risk at the Time of Fall

The risk incurred when a drone falls differs considerably depending on what is present at the place where the drone fell, more than the damage to the drone itself described above. Therefore, in this modification, related information acquiring unit 101 acquires information indicating the land type around a facility to be inspected as the related information. The land type indicates a type for classifying land by application such as residential land, commercial land, industrial land, farm land, or forest land, for example.

Related information acquiring unit 101 stores a map of an area including a facility to be inspected, and map data indicating the land type in the area, in advance, for example. The classification of the land type may be performed using the registered classification of land category, or using categorization (categorization of a residence, a house, a factory, and the like) in a commercial map, for example. Related information acquiring unit 101 specifies the position of a facility to be inspected on a map, and acquires the land type around the specified position from the stored map data.

Required skill determining unit 103 makes a determination such that, as the influence of falling of drone 20 on the land of a type indicated by the related information acquired by the related information acquiring unit 101 increases, the required skill is higher. The influence of falling of drone 20 increases in an area where more people are present (because the possibility of hitting a person and causing injury increases). Making a determination such that the larger the influence at the time of fall, the required skill is higher, makes the area in which the number of people is large be associated with higher required skill.

Also, the land type indicates tendency of how many people are likely to be in the area (a large number of people in residential land, a small number of people in farm land, and the like). Therefore, required skill determining unit 103 performs determination using a required skill table in which a land type is associated with a required skill.

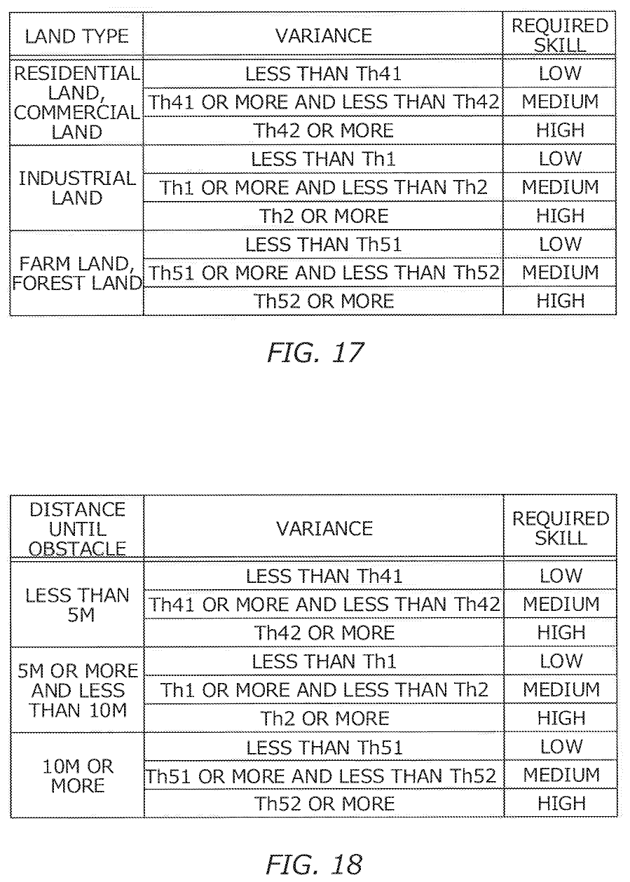

FIG. 17 shows an example of the required skill table in this modification. In the example in FIG. 17, the “residential land, commercial land”, “Industrial land”, and “Farm land, Forest land” land types are associated with variances and required skills.

Variances and required skills associated with the size “Large” shown in FIG. 16B are associated with “Residential land, Commercial land”, variances and required skills associated with the size “Medium” shown in FIG. 16B are associated with “Industrial land”, and variances and required skills associated with the size “Small” shown in FIG. 16B are associated with “Farm land, Forest land”. Therefore, in the case of a facility for which the variance is Th1 or more and less than Th51, if the land type around the facility is “Industrial land”, the required skill is “Medium”, and if the land type around the facility is “Farm land, Forest land”, the required skill is “Low”, for example.

Also, in the case of a facility for which the variance is Th42 or more and less than Th2, if the land type around the facility is “Industrial land”, the required skill is “Medium”, and if the land type around the facility is “Residential land, Commercial land”, the required skill is “High”. The number of people is larger in “Industrial land” than in “Farm land, Forest land”, and the number of people is larger in “Residential land, Commercial land” than in “Industrial land”. Therefore, if drone 20 does happen to fall, the risk of injuring a person is higher in “Industrial land” than in “Farm land, Forest land”, and is further higher in “Residential land, Commercial land”.

As described above, required skill determining unit 103 makes a determination such that as the number of people in a place of the land type indicated by the acquired related information increases, the required skill increases. The higher the operator's skill, the higher the likelihood of being able to avoiding a fall if some sort of problem occurs (gust of wind and failure, and the like) during flight. In this modification, the higher the risk of injuring a person when drone does happen to fall regarding a facility, the higher the required skill is determined, and therefore, a limited number of highly skilled operators can be appropriately assigned to facilities for which the risk when a drone falls is high.

2-4 Obstacles

There are cases where obstacles that hamper the flight of a drone are present in a surrounding area of a facility. Obstacles include moving objects such as birds and other drones, in addition to stationary objects such as buildings and trees, for example. The level of required skill differs between a facility with an obstacle and a facility without an obstacle. Therefore, in this modification, related information acquiring unit 101 acquires information (obstacle information) indicating obstacles that are present in a surrounding area of a facility to be inspected as the related information.

Related information acquiring unit 101 acquires information indicating the positions, shapes, and sizes of buildings and trees in a surrounding area of the facility from a service providing three-dimensional map information called a 3D map, as the obstacle information, for example. Also, related information acquiring unit 101 acquires information indicating the locations of birds (places where birds are obstacles) from a service providing information regarding locations and observable periods of wild birds for bird watchers, as the obstacle information, for example.

Also, related information acquiring unit 101 acquires information indicating public places (places that are not on private land) that are not flight prohibited areas of drones, that is, regions in which drones are allowed to fly following determined flight rules (flight possible region: place in which another drone is an obstacle), as the obstacle information. Required skill determining unit 103 makes a determination such that as the difficulty in avoiding an obstacle indicated by the related information acquired by related information acquiring unit 101 increases, the required skill increases.

Required skill determining unit 103 makes a determination such that, as the distance between the obstacle indicated by the acquired related information and the facility decreases, the required skill increases because avoidance is difficult, for example.

FIG. 18 shows an example of the required skill table in this modification. In the example in FIG. 18, the distances, from a facility to an obstacle, of “less than 5 m”, “5 m or more and less than 10 m”, and “10 m or more” are associated with variances and required skills (the distances are merely an example, and may also be different distances).

Variances and required skills associated with the size “Large” shown in FIG. 16B are associated with “Less than 5 m”, variances and required skills associated with the size “Medium” shown in FIG. 16B are associated with “5 m or more and less than 10 m”, and variances and required skills associated with the size “Small” shown in FIG. 16B are associated with “10 m or more”. Therefore, in the case of a facility for which the variance is Th1 or more and less than Th51, if the distance from the facility to an obstacle is “10 m or more”, the required skill is “Low”, and if the distance from the facility to an obstacle is “5 m or more and less than 10 m”, the required skill is “Medium”.

Also, in the case of a facility for which the variance is Th42 or more and less than Th2, if the aforementioned distance is “5 m or more and less than 10 m”, the required skill is “Medium”, and if the aforementioned distance is “less than 5 m”, the required skill is “High”. As described above, required skill determining unit 103 makes a determination such that, even if the variance is the same, as the distance from the facility to an obstacle decreases, the required skill increases. Also, required skill determining unit 103 may make a determination such that, when the obstacle information indicates locations of birds and flight allowed regions of drones, even if the distance to an obstacle is the same, the required skill is higher, compared with the case where obstacle information indicates buildings and trees.

When the aforementioned determination is made, required skill determining unit 103 uses different required skill tables depending on the type of obstacle. Required skill determining unit 103 uses the required skill table shown in FIG. 18 if the obstacle information indicates buildings and trees, and uses a required skill table in which the required skill is likely to be higher relative to the case where the required skill table shown in FIG. 18 is used (threshold values of variance are reduced on the whole) if the obstacle information indicates locations of birds and flight allowed regions of drones.

As the distance from a facility to an obstacle decreases, the likelihood of a drone coming into contact with the obstacle increases when shooting flight is performed, and therefore higher skill is required. In this modification, as a result of performing determination considering the obstacle information, a highly skilled operator is assigned to a facility with respect to which an obstacle is closer than other facilities, and therefore the risk of drone 20 falling due to contact with an obstacle can be reduced, compared to a case where the obstacle information is not considered.

2-5 Operation of Acquiring Inspection Data

When drone 20 acquires inspection data based on remote operations using proportional controller 30 or the like, there are cases where high operator skill is required depending on the method of acquiring inspection data. Therefore, in this modification, related information acquiring unit 101 acquires information indicating the method of acquiring inspection data as the related information.

The method of acquiring inspection data includes a method of pressing an acquisition button (shooting button in the embodiment) at fixed intervals of a flight distance, a method of pressing an acquisition button in a state in which drone 20 is inclined (in a state of having an angle of elevation or angle of dip), and a method of acquiring a plurality of pieces of inspection data while changing the angle of drone 20 in the same location, for example. The method of acquiring inspection data is determined for each facility in advance, and the information indicating the acquiring method for each facility is assumed to be stored in base terminal 40, server apparatus 10, or the like.

Related information acquiring unit 101 acquires information indicating the method of acquiring inspection data stored in an external apparatus or the corresponding drone as the related information. Required skill determining unit 103 makes a determination such that the higher the degree of difficulty of the operation for realizing at least one of the inclination and position of drone 20 when inspection data is acquired with the acquiring method indicated by the related information acquired by related information acquiring unit 101, the higher the required skill.

When drone 20 is caused to rise in the vertical direction, drone 20 usually takes an attitude along the horizontal direction with no inclination (horizontal posture), and therefore it is relatively easy to acquire the inspection data while keeping the horizontal attitude. However, if drone 20 is caused to take an inclined posture in order to have an angle of dip or an angle of elevation, drone 20 is likely to move in the inclined direction, and it becomes more difficult to acquire inspection data in a state in which drone 20 is at an intended position, as the inclination of drone 20 relative to the horizontal direction increases, for example.

Also, with the method of acquiring inspection data at multiple angles in which inspection data regarding the same location is acquired at different angles as well, drone 20 needs to be caused to fly to a plurality of positions from which the location can be photographed, and needs to be caused to fly at inclinations according to the respective positions, that is, the number of the position and inclination of drone 20 are adjusted to a position and inclination needed to acquire inspection data is large, and therefore the degree of difficulty increases compared to the method of acquiring inspection data at a single angle.

As described above, the method of acquiring inspection data is associated with the degree of difficulty in operation, and therefore, required skill determining unit 103 performs determination using a required skill table in which the method of acquiring inspection data is associated with the required skill.

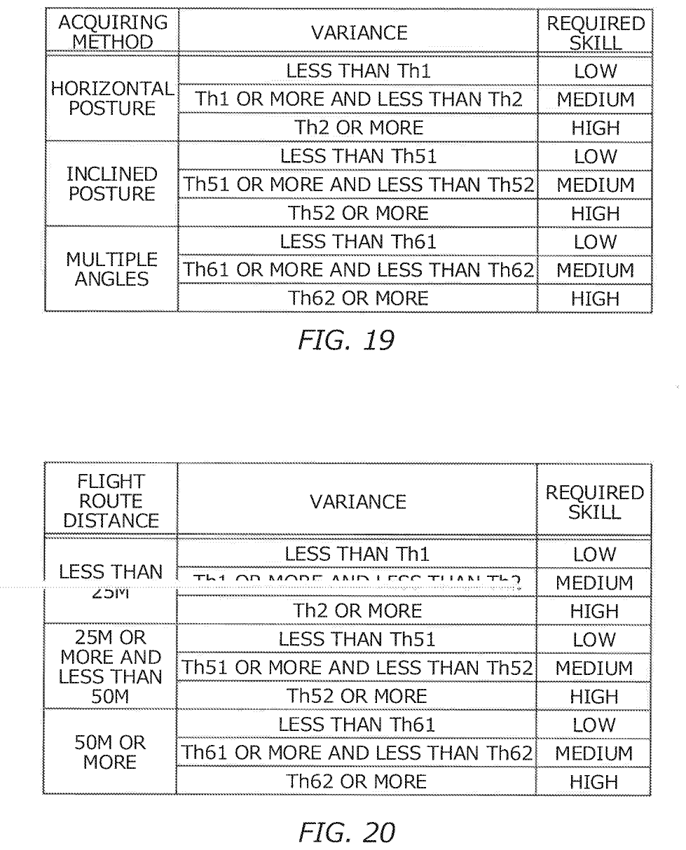

FIG. 19 shows an example of the required skill table of this modification. In the example in FIG. 19, methods of acquiring inspection data, namely, “Horizontal posture”, “Inclined posture”, and “Multiple angles”, are associated with variances and required skills.

“Horizontal posture” is associated with the variance and required skill that are the same as the size “Medium” shown in FIG. 16B, and “Inclined posture” is associated with the variance and required skill that are the same as the size “Small” shown in FIG. 16B. Also, regarding “Multiple angles”, variances of “Less than Th61”, “Th61 or more and less than Th62”, and “Th62 or more” are respectively assigned “Low”, “Medium”, and “High” required skills. In the example in FIG. 19, the magnitude relationship of the thresholds is assumed to be Th1>Th51>Th61 and Th2>Th52>Th62.

For example, in the case of a facility for which the variance is Th51 or more and less than Th1, if the method of acquiring inspection data is “Horizontal posture”, the required skill is “Low”, and the method of acquiring inspection data is “Inclined posture”, the required skill is “Medium”. That is, in the example in FIG. 19, required skill determining unit 103 makes a determination such that as the inclination of drone 20 (relative to the horizontal direction) increases, the required skill increases.

Also, in the case of a facility for which the variance is Th62 or more and less than Th52, if the method of acquiring inspection data is “Inclined posture”, the required skill is “Medium”, and if the method of acquiring inspection data is “Multiple angles”, the required skill is “High”. The acquiring method in “Inclined posture” is a method of acquiring inspection data at a single angle. That is, in the example in FIG. 19, required skill determining unit 103 makes a determination such that as the number of times of the position and inclination of drone 20 are adjusted to the position and inclination that are needed for acquiring inspection data increases, the required skill increases.

As described above, required skill determining unit 103 makes a determination such that, even if the variance is the same, as the degree of difficulty of the operation for realizing at least one of the inclination and position of drone 20 increases when inspection data is acquired, the required skill increases. If inspection data is acquired through an operation made by an operator who is insufficiently skilled, the accuracy of the inspection data degrades (in the case of shooting, for example, it is likely that an intended location was not shot at an intended angle), and therefore erroneous determination is likely to be made regarding whether or not damage is present and whether or not repair is required.

In this modification, a method of acquiring inspection data is used in which as the degree of difficulty of the operation for realizing at least one of the inclination and position of drone 20 increases when inspection data is acquired, the higher the required skill is, as described above, and therefore a limited number of highly skilled operators can be appropriately assigned, and erroneous determination is unlikely to be made regarding whether or not damage is present and whether or not repair is required, compared with a case where the level of difficulty in operation is not considered.

2-6 Visibility of Drone: Distance

As the visibility of drone 20 decreases, the operation of drone 20 becomes more difficult. For example, as drone 20 moves away from an operator, the size of drone 20 viewed by the operator decreases, and it is more difficult for the operator to grasp the posture and flight direction, and as a result, the operation for causing drone 20 to make an intended flight becomes difficult. When inspection data of a facility is acquired, the level of required skill differs between a case where drone 20 needs to be operated from a position at a long distance and a case where drone 20 can be operated from a position at a short distance.

Therefore, in this modification, the required skill is determined according to the visibility of drone 20. Related information acquiring unit 101 acquires information indicating the place from which an operator of drone 20 makes an operation, as the related information. Related information acquiring unit 101 stores information (hereinafter referred to as “operation place information”) indicating places from which operators make operations (hereinafter referred to as “operation place”) at each base station, in advance, for example. The operation places include a place at the base of an antenna facility of the base station, a roof floor of a building at the base station, a raised platform outside the base station area, and the like.

The operation place information is information representing an operation place with three-dimensional coordinates (latitude, longitude, and height), for example. Related information acquiring unit 101 supplies the acquired operation place information to required skill determining unit 103 as the related information. Required skill determining unit 103 makes a determination such that as the distance between the operation place indicated by the related information acquired by related information acquiring unit 101 and the flight route of drone 20 (hereinafter, referred to as “flight route distance”) increases, the required skill increases.

FIG. 20 shows an example of the required skill table of this modification. In the example in FIG. 20, the distances between drone 20 and an operator, namely “Less than 25 m”, “25 m or more and less than 50 m”, and “50 m or more” are associated with variances and required skills (the distances are merely an example and may be distances different from those in the example in FIG. 20). “Less than 25 m” is associated with the variances and required skills that are the same as “Horizontal posture” shown in FIG. 19, “25 m or more and less than 50 m” is associated with the variances and required skills that are the same as “Inclined posture” shown in FIG. 19, and “50 m or more” is associated with the variances and required skills that are the same as “Multiple angles” shown in FIG. 19.

Required skill determining unit 103 calculates a distance between a location that is farthest from an operation place and the operation place, of the flight route, (that is, longest distance), as the flight route distance, for example. For example, in the case where the facility to be inspected is an antenna facility of a base station, the flight route in the vicinity of an apex of the antenna facility is the location that is farthest from an operation place. Therefore, required skill determining unit 103 calculates the distance between the operation place indicated by the operation place information and the apex of the antenna facility as the flight route distance.

Note that in the case of an operation place that is farther from a base of an antenna facility than an apex thereof, required skill determining unit 103 calculates the distance between the operation place indicated by the operation place information and the base of the antenna facility as the flight route distance. Also, required skill determining unit 103 may also calculate an average distance between a plurality of locations on a flight route from a location in the vicinity of the base to a location in the vicinity of the apex of the antenna facility and the operation place as the flight route distance, instead of the longest distance (also, it is desirable that different required skill tables are used between longest distance and average distance).

Required skill determining unit 103 determines required skill associated with the calculated flight route distance in the required skill table as the required skill in the base station for which the flight route distance has been calculated. For example, in the case of a facility for which the variance is Th51 or more and less than Th1, if the distance between drone 20 and an operator is “Less than 25 m”, the required skill is “Low”, and if the distance between drone 20 and an operator is “25 m or more and less than 50 m”, the required skill is “Medium”.

Also, in the case of a facility for which the variance is Th62 or more and less than Th52, if the distance between drone 20 and an operator is “25 m or more and less than 50 m”, the required skill is “Medium”, and if the distance between drone 20 and an operator is “50 m or more”, the required skill is “High”. As described above, required skill determining unit 103 makes a determination such that, even if the variance is the same, as the flight route distance increases, the required skill increases.

As described above, as the distance between drone 20 and an operator increases, the visibility degrades, and therefore the operation becomes more difficult, and higher skill is required. According to this modification, the required skill is determined according to the flight route distance, as described above, and therefore the risk of drone 20 falling due to an operation error at a long distance can be reduced compared to a case where the required skill is determined without considering the flight route distance.

2-7 Visibility of Drone: Obstruction

The visibility of drone 20 is degraded by an obstruction that interrupts the field of view of an operator, in addition to the distance from the operator, for example. Note that invisible flight is prohibited in principle, but a case may occur where drone 20 is temporarily invisible such as a case where drone 20 passes behind an obstruction and returns, for example.

In this modification, related information acquiring unit 101 acquires the operation place information described above as the related information. Then, required skill determining unit 103 makes a determination such that as the range increases in which the flight route of drone 20 is invisible, viewed from the operation place indicated by the related information acquired by the related information acquiring unit 101, the required skill increases. The range in which the flight route is invisible is a range in which an obstruction is present between the installation site and the flight route, and hereinafter, is referred to as “obstructed range”. The obstruction is an object to be inspected itself, such as a building or a tree that is preset in the vicinity of the object to be inspected, for example.

Required skill determining unit 103 uses a required skill table in which the ratio of the shielded range is associated with the variance and required skill, in this modification. The ratio of the shielded range means the ratio of directions in which a shield is present when all directions are viewed from the operation place.

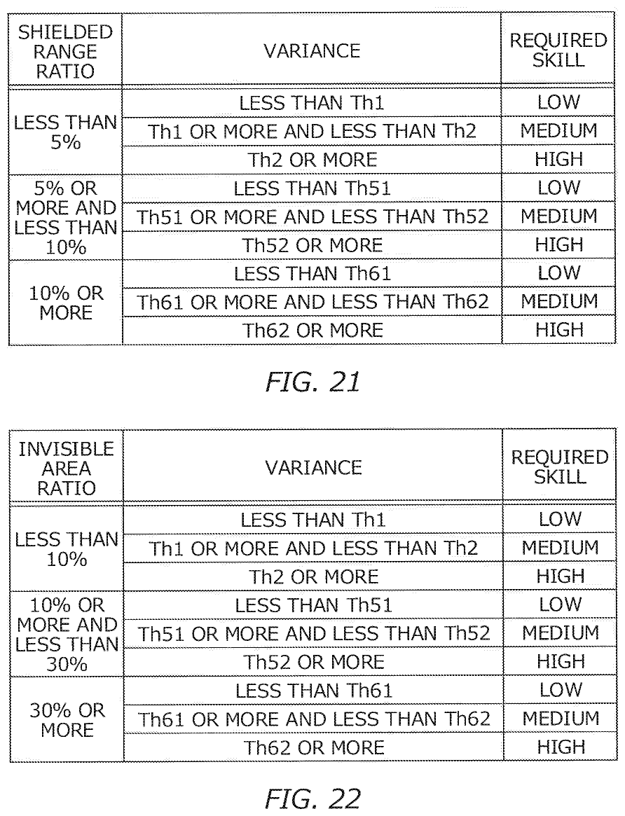

FIG. 21 shows an example of the required skill table in this modification. In the example of FIG. 21, the ratios of shielded range, namely “Less than 5%”, “5% or more and less than 10%”, and “10% or more”, are associated with variances and required skills.

The variances and required skills that are the same as those of “Horizontal posture” shown in FIG. 19 are associated with “Less than 5%”, the variances and required skills that are the same as those of “Inclined posture” shown in FIG. 19 are associated with “5% or more and less than 10%”, and the variances and required skills that are the same as those of “Multiple angles” shown in FIG. 19 are associated with “10% or more”. For example, in the case of a facility for which the variance is Th51 or more and less than Th1, if the ratio of shielded range is “Less than 5%”, the required skill is “Low”, and if the ratio of shielded range is “5% or more and less than 10%”, the required skill is “Medium”.

Also, in the case of a facility for which the variance is Th62 or more and less than Th52, if the ratio of shielded range is “5% or more and less than 10%”, the required skill is “Medium”, and if the ratio of shielded range described above is “10% or more”, the required skill is “High”. As described above, in this modification, required skill determining unit 103 makes a determination such that, even if the variance is the same, as the range in which the flight route is invisible increases, the required skill increases.

As described above, as the ratio of shielded range increases, the operation becomes more difficult, and therefore higher skill is required. According to this modification, with respect to a facility for which the ratio of shielded range is larger than other facilities, a highly skilled operator is assigned, and therefore the risk of drone 20 falling due to an operation error when drone 20 is temporarily made invisible by an obstruction can be reduced compared to a case where the required skill is determined without considering the range in which the flight route is invisible.

2-8 Area Invisible from Operator

There are cases where inspection data regarding an area that is not directly visible to an operator (hereinafter referred to as “invisible area”) is acquired depending on the facility to be inspected. For example, in the case of an antenna facility that is installed at an end of a roof floor of a building, an area that is facing in a direction that is not visible from a roof floor is an invisible area. When inspection data regarding an invisible area is acquired, an operator needs to fly drone 20 while estimating the positional relationship between the invisible area and drone 20.

Therefore, the operation is more difficult relative to the case of acquiring inspection data regarding a visible area, and it is difficult to acquire highly accurate inspection data (e.g., photograph of an intended area at an intended angle and size). Therefore, in this modification, related information acquiring unit 101 acquires information indicating the ratio of areas, of a facility to be inspected, that are not directly visible to an operator (invisible area) as the related information. Related information acquiring unit 101 acquires information indicating the type of a facility in which an antenna facility is installed (installed facility) and information indicating the installation position in the installed facility as the related information, for example.

For example, in a case where an antenna facility is installed in a facility that is secured for a base station, an operator can change the position of the drone? in any direction, and therefore the invisible area ratio is 0%. However, if there is a building adjacent to an antenna facility, the antenna facility may not be viewable from the direction in which the adjacent building is present, and therefore the ratio of the angle occupied by the adjacent building, of all directions, is the invisible area ratio.

Also, when an antenna facility is installed on a roof floor of a building, if the installation position is at the center of the roof floor, the invisible area ratio is 0%, but if the installation position is a position corresponding to a side of the roof floor, an invisible area occurs (the invisible area ratio is about 25%, for example), and if the installation position is a position corresponding to a corner of the roof floor, the invisible area further increases (the invisible area ratio is about 50%, for example). Required skill determining unit 103 makes a determination such that as the invisible area indicated by the related information acquired by related information acquiring unit 101 increases, the required skill increases.

FIG. 22 shows an example of the required skill table in this modification. In the example in FIG. 22, the ratios of invisible area, namely “Less than 10%”, “10% or more and less than 30%”, and “30% or more”, are associated with variances and required skills (the ratios are merely an example, and may also be different ratios). The variances and required skills that are the same as those of “Horizontal posture” shown in FIG. 19 are associated with “less than 10%”, the variances and required skills that are the same as those of “Inclined posture” shown in FIG. 19 are associated with “10% or more and less than 30%”, and the variances and required skills that are the same as those of “Multiple angles” shown in FIG. 19 are associated with “30% or more”.

For example, in the case of a facility for which the variance is Th51 or more and less than Th1, if the invisible area ratio is “Less than 10%”, the required skill is “Low”, and if the invisible area ratio is “10% or more and less than 30%”, the required skill is “Medium”. Also, in the case of a facility for which the variance is Th62 or more and less than Th52, if the invisible area ratio is “10% or more and less than 30%”, the required skill is “Medium”, and if the invisible area ratio described above is “30% or more”, the required skill is “High”.

As described above, required skill determining unit 103 makes a determination such that, even if the variance is the same, as the invisible area ratio increases, the required skill increases. As described above, as the invisible area ratio increases, the operation becomes more difficult, and therefore higher skill is needed in order to acquire highly accurate inspection data. According to this modification, with respect to a facility for which the invisible area ratio is larger than other facilities, a highly skilled operator is assigned, and therefore inspection data with higher accuracy can be acquired with respect to an invisible area relative to the case where the invisible area ratio is not considered.

2-9 Degradation Level of Facility

As the degradation of a facility to be inspected progresses, the necessity of repair increases, and therefore inspection data with high accuracy is needed in order to not overlook a damage. Therefore, in this modification, related information acquiring unit 101 acquires information indicating the degradation level of a facility to be inspected (degradation level information) as the related information.

Related information acquiring unit 101 acquires information indicating the date at which an antenna facility was installed and the date at which the antenna facility was repaired as the related information (degradation level information), for example. It is shown that degradation of an antenna facility progresses as the length of time that has elapsed from installation and from repair increases. Required skill determining unit 103 makes a determination such that, as the degradation level of a facility indicated by the related information acquired by related information acquiring unit 101 increases, the required skill increases.

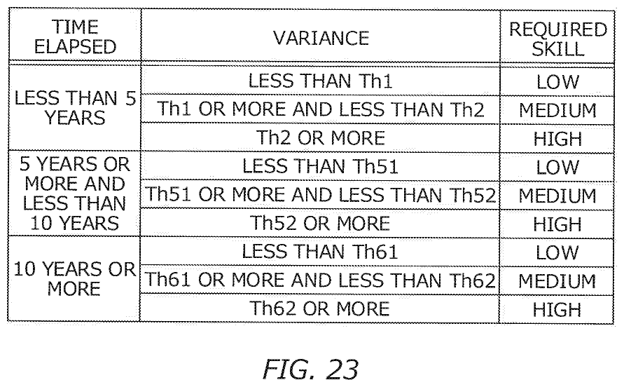

FIG. 23 shows an example of the required skill table in this modification. In the example in FIG. 23, times elapsed of “Less than 5 years”, “5 years or more and less than 10 years”, and “10 years or more”, are associated with variances and required skills. The time elapsed is the time elapsed since installation itself if no repair has been performed, and if a repair has been performed, the time elapsed is the time obtained by adding the time elapsed since the repair and the time obtained by halving the period from the installation to the repair (because degradation of portions that have not been repaired progresses), for example.

Note that when repair has been performed, the time elapsed since the repair may be used as the time elapsed, or the time elapsed since the installation may also be used as the time elapsed without considering the repair. Note that the times elapsed described above are merely an example and times elapsed that are different from those in FIG. 23 may also be used. In the example in FIG. 23, the variances and required skills that are the same as those of “Horizontal posture” shown in FIG. 19 are associated with “Less than 5 years”, the variances and required skills that are the same as those of “Inclined posture” shown in FIG. 19 are associated with “5 years or more and less than 10 years”, and the variances and required skills that are the same as those of “Multiple angles” shown in FIG. 19 are associated with “10 years or more”.

For example, in the case of a facility for which the variance is Th51 or more and less than Th1, if the time elapsed is “Less than 5 years”, the required skill is “Low, and if the time elapsed is “5 years or more and less than 10 years”, the required skill is “Medium”. Also, in the case of a facility for which the variance is Th62 or more and less than Th52, if the time elapsed is “5 years or more and less than 10 years”, the required skill is “Medium”, and if the time elapsed is “10 years or more”, the required skill is “High”. As described above, required skill determining unit 103 makes a determination such that, even if the variance is the same, as the time elapsed increases and the degradation level increases, the required skill increases.

As described above, as the degradation level of a facility to be inspected increases, higher skill is needed in order to acquire highly accurate inspection data. According to this modification, with respect to a facility for which the degradation level is higher than other facilities, a highly skilled operator is assigned, and therefore highly accurate inspection data can be acquired with respect to a facility for which the degradation level is higher and the necessity of repair is higher than other facilities, relative to the case where the degradation levels of facilities are not considered.

2-10 Flying Body

In the embodiment, a rotary blade-type flying body is used as a flying body that performs autonomous flight, but there is no limitation thereto. For example, the flying body that performs autonomous flight may be an airplane-type flying body or may be a helicopter-type flying body. In other words, any flying body that can make a flight by operation by an operator and has a function of acquiring inspection data may be used.

2-11 Apparatuses Realizing Functions

The apparatus that realizes the functions shown in FIG. 6 are not limited to the apparatuses described above. For example, the functions realized by server apparatus 10 may also be realized by proportional controller 30 or base terminal 40. In this case, proportional controller 30 or base terminal 40 is an example of the “information processing apparatus” of the present invention. In short, it is sufficient that the functions shown in FIG. 6 are realized in facility inspection system 1 as a whole.

2-12 Category of the Invention

The present invention may be understood as, other than information processing apparatuses such as server apparatus 10 described above, an information processing system (facility inspection system 1) including the information processing apparatuses and flying bodies such as drone 20. The present invention can also be understood as an information processing method for realizing the processing implemented by the information processing apparatuses, or as a program for causing a computer to control the information processing apparatuses. The program that is understood as the present invention may be provided in the form of a recording medium such as an optical disk where the program is stored, or may be provided in the form in which a computer is caused to download the program via a network such as the Internet, and the downloaded program is installed so as to be usable, or the like.

2-13 Functional Blocks

Note that the block diagrams used in the description of the embodiment described above show blocks of functional units. These functional blocks (constituent units) are realized by any combination of at least one of hardware and software. The method of realizing the function blocks is not limited in particular.

That is, the functional blocks may be realized by using one apparatus in which the functional blocks are physically or logically connected, or may be realized by directly or indirectly connecting two or more apparatus that are physically or logically separated (using, for example, a wired connection, a wireless connection, or the like), and using the plurality of these apparatus. Functional blocks may also be realized by combining the one apparatus or the plurality of apparatus with software.

Examples of functions include determining, deciding, judging, calculating, computing, processing, deriving, investigating, searching, confirming, receiving, transmitting, outputting, accessing, solving, selecting, setting, establishing, comparing, assuming, expecting, considering, broadcasting, notifying, communicating, forwarding, configuring, reconfiguring, allocating, mapping, assigning, and the like, but these are no limitation thereto. For example, a functional block (constituent unit) that enables transmission function is called a transmission unit or a transmitter. In any case, as described above, the method of realizing a function is not particularly limited.

2-14 Handling of Input/Output Information and the Like

Information and the like that has been input/output may be saved in a specific location (for example, a memory), or may be managed using a management table. The information and the like that is input/output can be overwritten, updated, or added to. Information and the like that has been output may be deleted. Information and the like that has been input may also be transmitted to another apparatus.

2-15 Determination Method

Determination may be performed according to a value (0 or 1) represented by 1 bit, or may be performed according to a Boolean value (Boolean: true or false), or may be performed by comparing numerical values (for example, comparison with a predetermined value).

2-16 Processing Procedure and the Like

The processing procedures, sequences, flowcharts, and the like of the modes and embodiments described in this disclosure may be carried out in different orders as long as doing so does not create conflict. For example, in the methods described in the present disclosure, the elements of various steps are presented in an exemplary order, and the order is not limited to the specific order presented here.

2-17 Handling of Input/Output Information and the Like

Information and the like that has been input/output may be saved in a specific location (for example, a memory), or may be managed using a management table. The information and the like that is input/output can be overwritten, updated, or added to. Information and the like that has been output may be deleted. Information and the like that has been input may be transmitted to another apparatus.

2-18 Software

Regardless of whether software is referred to as software, firmware, middleware, microcode, hardware description language, or by another name, “software” should be interpreted broadly as meaning commands, command sets, codes, code segments, program codes, programs, sub programs, software modules, applications, software applications, software packages, routines, subroutines, objects, executable files, execution threads, sequences, functions, and the like.

Also, software, commands, information, and the like may be exchanged over a transmission medium. For example, when software is transmitted from a website, a server, or another remote source using wired technologies such as coaxial cable, fiber optic cable, twisted pair cabling, or digital subscriber line (DSL), and/or wireless technologies such as infrared light or microwaves, at least one of these wired technologies and wireless technologies is included in the definition of “transmission medium”.

2-19 Information and Signals

The information, signals, and the like described in the present disclosure may be expressed using any of a variety of different techniques. For example, data, instructions, commands, information, signals, bits, symbols, chips, and the like that may be referred to throughout all of the foregoing descriptions may be expressed by voltages, currents, electromagnetic waves, magnetic fields or magnetic particles, photo fields or photons, or any desired combination thereof.

2-20 Determining

The term “determining” as used in this disclosure may encompass a wide variety of actions. For example, performing any action of judging, calculating, computing, processing, deriving, investigating, looking up, searching, inquiring (for example, searching in a table, a database, or another data structure), ascertaining or the like may be considered as performing an action of “determining”.

Also, for example, performing any action of receiving (for example, receiving information), transmitting (for example, transmitting information), input, output, accessing (for example, accessing data in memory) or the like may be considered as performing an action of “determining”. Also, performing any action of resolving, selecting, choosing, establishing, comparing, or the like may be considered as performing an action of “determining”. That is, performing some action may be considered as performing an action of “determining”. Also, the term “determining” may be replaced with “assuming”, “expecting”, “considering”, or the like.

2-21 Meaning of “Based On”

The phrase “based on” used in the present disclosure does not mean “based only on” unless specifically mentioned. In other words, the phrase “based on” means both “based only on” and “based at least on”.

2-22 “Different”

In the present disclosure, the phrase “A and B are different” may mean “A and B are different from each other”. This phrase may mean that “A and B are each different from C”. Terms such as “separate” and “connected” may be construed in a similar manner as “different”.

2-23 “And” and “Or”

In the present disclosure, with respect to configurations that can be realized both as “A and B” and “A or B”, a configuration described using one of these phrases may be used as a configuration described by the other of these phrases. For example, if the phrase “A and B” is used, “A or B” may be used as long as implementation is possible without conflicting with the other phrase.

2-24 Variations and the Like of Modes

The modes and embodiments described in the present disclosure may be used alone, may be combined, or may be switched according to how the invention is to be carried out. Additionally, notifications of predetermined information (for example, a notification that “X is true”) are not limited to explicit notifications, and may be carried out implicitly (for example, the notification of the predetermined information is not carried out).

Although the foregoing has described the present disclosure in detail, it will be clear to one skilled in the art that the present disclosure is not intended to be limited to the embodiments described in the present disclosure. The present disclosure can be carried out in modified and altered forms without departing from the gist and scope of the present disclosure set forth in the appended scope of patent claims. As such, the descriptions in the present disclosure are provided for illustrative purposes only, and are not intended to limit the present disclosure in any way.

### REFERENCE SIGNS LIST

1 Facility inspection system
2 Network
3, 4 Antenna facility
6, 7, 8 Base station
10 Server apparatus
20 Drone
30 Proportional controller
40 Base terminal
101 Related information acquiring unit
102 Facility information storage unit
103 Required skill determining unit
104 Operation plan generating unit
105 Operator information storage unit
401 Operation plan display unit

What is claimed is:

1.-10. (canceled)

11. An information processing apparatus comprising:
an acquiring unit configured to acquire related information related to a facility to be inspected; and
a determining unit configured to determine, when inspection data regarding the facility is acquired by causing a flying body to make a flight around the facility, a required skill needed to operate the flying body based on the acquired related information.

12. The information processing apparatus according to claim 11,
wherein the acquiring unit acquires information indicating a shape of the facility as the related information, and
the determining unit makes a determination such that, the higher a level of complexity of a flight route along the shape represented by the acquired related information is, the higher the required skill is.

13. The information processing apparatus according to claim 11,
wherein the acquiring unit acquires information indicating weather around the facility as the related information, and
the determining unit makes a determination such that, the higher a degree to which the flight is disturbed by the weather indicated by the acquired related information is, the higher the required skill is.

14. The information processing apparatus according to claim 11,
wherein the acquiring unit further acquires specification information regarding the flying body, and
the determining unit determines the required skill based on the acquired related information and the specification information.

15. The information processing apparatus according to claim 11,
wherein the acquiring unit acquires information indicating a land type around the facility as the related information, and
the determining unit determines that, the greater a magnitude of influence when the flying body falls in a land of the land type indicated by the acquired related information is, the higher the required skill is.

16. The information processing apparatus according to claim 11,
wherein the acquiring unit acquires information indicating an obstacle that is present in a vicinity of the facility as the related information, and
the determining unit determines that the higher a degree of difficulty in avoiding the obstacle indicated by the acquired related information is, the higher the required skill is.

17. The information processing apparatus according to claim 11,
wherein the flying body acquires the inspection data based on a remote operation,
the acquiring unit acquires information indicating a method of acquiring the inspection data as the related information, and
the determining unit determines that, when the inspection data is acquired with the method indicated by the acquired related information, the greater an inclination of the flying body is, or the larger the number of times of a position and an inclination of the flying body are adjusted to another position and another inclination that are required to acquire the inspection data is, the higher the required skill is.

18. The information processing apparatus according to claim 11,
wherein the acquiring unit acquires information indicating a place from which an operator of the flying body performs an operation as the related information, and
the determining unit makes a determination such that, the greater a distance between the place indicated by the acquired related information and a flight route of the flying body is, or the greater a range in which a flight route of the flying body is invisible as viewed from the place is, the higher the required skill is.

19. The information processing apparatus according to claim 11,
wherein the acquiring unit acquires information indicating a degradation level of the facility as the related information, and
the determining unit determines that, the greater the degradation level indicated by the acquired related information is, the higher the required skill is.

20. The information processing apparatus according to claim 11, further comprising
a generating unit configured to generate an operation plan for causing the flying body to make a flight while visiting facilities for which a level of the determined required skill is the same.
